(19) United States
(12) Patent Application Publication
(10) Pub. No.: US 2008/0028130 A1
(43) Pub. Date: Jan. 31, 2008

(54) Mass memory device and semiconductor memory card

(76) Inventor: Otto Winkler, Hebertsfelden (DE)

Correspondence Address: SLATER & MATSIL LLP, 17950 PRESTON ROAD, SUITE 1000, DALLAS, TX, 75252, US

(21) Appl. No.: 11/513,839

(22) Filed: Aug. 31, 2006

(30) Foreign Application Priority Data
Jul. 31, 2006 (DE) 10 2006 035 633.0

(51) Int. Cl. G06F 12/00

(52) U.S. Cl. 711/103

(57) ABSTRACT

A mass memory device has a nonvolatile semiconductor memory device that can be accessed via a contact bank using an access device. An auxiliary device can be used to read data stored in the semiconductor memory device without going through the access device.

This application claims priority to German Patent Application 10 2006 035 633.0, which was filed Jul. 31, 2006 and is incorporated herein by reference.

### TECHNICAL FIELD

The invention relates to a mass memory device and to a semiconductor memory card.

### BACKGROUND

Mass memory devices and semiconductor memory cards, such as so-called multimedia cards, USB memory sticks, etc., are known in diverse ways. These devices have a nonvolatile memory, which is currently essentially so-called “flash memory.” Within the housing, there is currently often a processor chip, which is connected to the at least one or else more memory chips. In addition, there is a contact bank via, which a mass memory device of this kind is connected to an external appliance such as PC, Notebook or else a camera, movie camera, audio player, etc.

For communication between the external appliance on the one hand and the memory device on the other, a standardized transmission protocol is accessed. To make it easier to meet the protocol standards, these appliances have the aforementioned processor, so that firstly it is possible to support the protocol and secondly targeted storage and access are possible within the memory device. To this end, the flash memory normally has a memory access device, usually found in circuits such as row and column decoders, sense amplifiers, etc., but also additional logic chips that manage access to the memory, particularly when a plurality of memory chips are present. Frequently, a flash memory chip is produced using different technology than the processor chip, the result of which is that the service life of the two chips often differs. Semiconductor memory devices normally have redundancies, which means that a fault in individual memory cells has no significant consequence. In addition, an error correction code is also normally used, which means that it is possible to correct failure of an individual memory cell or a plurality of memory cells. This means that if individual parts of the memory chip develop a fault and the processor is still working correctly the whole memory device can normally continue to be operated for a significant time longer.

By contrast, if an individual circuit part of the processor fails then this frequently results in it no longer being possible to access the memory, which means that the whole memory device is unusable. This in turn has the consequence that it is no longer possible to access the stored data. Such a scenario is troublesome particularly when data that cannot readily be recovered are stored in the semiconductor memory. It goes without saying that it is nowadays possible to open a memory device of this kind mechanically and to use suitable technology to access the semiconductor memory directly and recover the data stored therein. However, such a measure is associated with considerable complexity and enormous costs.

### SUMMARY OF THE INVENTION

In one aspect, the invention provides a mass memory device and a semiconductor memory card in which the data can at least be read easily if the processor fails. For example, a nonvolatile semiconductor memory device, which can be accessed via a contact bank using an access unit and has an auxiliary device that is used to read data stored in the semiconductor memory device by bypassing the access device. In addition, a semiconductor memory card is provided and includes a nonvolatile semiconductor memory and a processor device, which are arranged such that the processor device can be used to access the semiconductor memory. An auxiliary arrangement can be used to read data stored in the semiconductor memory.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 shows a first exemplary embodiment;

FIG. 2 shows a second exemplary embodiment; and

FIG. 3 shows a third exemplary embodiment.

The following list of reference symbols can be used in conjunction with the figures:

| | |
|---|---|
| 1 | Memory card |
| 2 | Semiconductor memory device, flash |
| | memory bank, semiconductor memory |
| 3 | Additional contact bank |
| 4 | Access device, processor device, |
| | processor |
| 5 | Contact bank |
| 6 | Interface circuit |
| 7 | Bypass bus |
| 8 | Contact bus |
| 9 | Interface bus |
| 10 | Access bus |
| 11 | Auxiliary bus |
| 12 | Control line |
| 13 | Memory interface |
| 14 | Memory auxiliary interface, state |
| | machine |

### DETAILED DESCRIPTION OF ILLUSTRATIVE EMBODIMENTS

The invention is explained below using exemplary embodiments with reference to the drawings.

FIG. 1 schematically shows the outline of the housing 1 of a memory card, in a form known as a multimedia card. Ratios of proportions have not been considered here. Contacts 5 can be accessed externally so that it is also possible to insert the card into an appliance that has corresponding mating contacts. In FIG. 1, the contacts are shown as a shaded area, since the actual contact arrangement can be diverse and has no kind of influence on the actual invention. Equally, the contacts 5 arranged as contact bank can also be the contacts of a USB card or of a USB memory stick or any other device.

The mechanical contacts are then connected to an interface circuit 6 via a contact bus 8 or via contact lines 8. An interface circuit 6 of this kind normally has at least line drivers, that is to say circuit elements that provide for the voltage levels, edge gradients and current levels prescribed in the transmission protocol. Often, an interface circuit of this kind also undertakes other functions in order to allow suitable adaptation to standard processors. In that case, the interface circuit 6 is connected via an interface bus 9 to the access device 4 or processor device, that is to say the processor 4, which undertakes the data management within the memory card shown. This processor itself is in turn connected via an access bus 10 to a memory interface 13, which is normally part of a flash memory bank 2 or of the semiconductor memory device 2.

The memory interface 13 is normally arranged on the same chip as the flash memory bank 2 and comprises at least row and column detectors and also circuits known as sense amplifiers, which actuate and read the individual memory cells.

In line with a first exemplary embodiment, a bypass bus 7 couples the memory interface 13 to the interface circuit 6. If the processor 4 fails or is faulty or is not operated then the flash memory bank 2 can be accessed directly without going through the processor 4. At the least, the stored data can be read. Since the support by the processor is now lacking, the required management activity needs to be performed via the software on an external appliance. This should not be a problem on a commercially available computer, e.g., personal computer, today, however. It would thus be possible to use the usual contacts 5 and the interface circuit 6 or the memory interface 3 to read the stored data from the individual segments at least in columns or rows and then in turn to compile them within the associated external appliance in line with the usual systematics, for example to form pictures, audio recordings, films, etc.

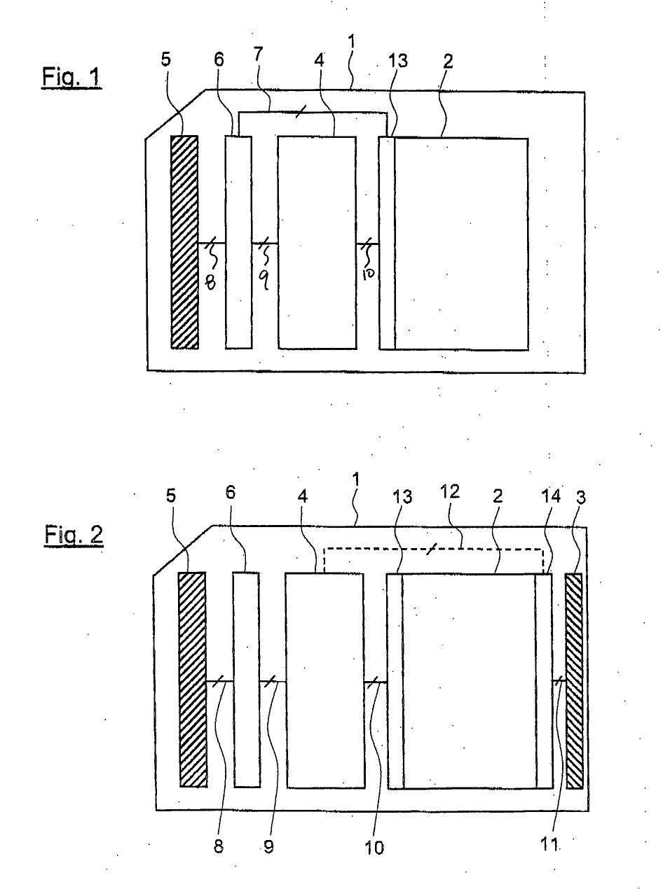

FIG. 2 shows another exemplary embodiment. Here, the same reference symbols denote the same elements. In this arrangement, an additional contact bank 3 is provided at that end of the memory card that is opposite the contact bank 5. This additional contact bank is coupled to a memory auxiliary interface 14 via an auxiliary bus 11. This memory auxiliary interface may be in the form of what is known as a “state machine,” which firstly provides the necessary line drivers and also allows the flash memory bank 2 to be read systematically using simple control signals. Optionally, provision may be made for a control line 12 to be used to activate and deactivate the memory auxiliary interface. This means that the arrangement may be in a form such that when the processor 4 is in operation and working correctly it transmits a deactivation signal to the memory auxiliary interface 14 via the control line, so that the memory auxiliary interface is deactivated. As soon as the processor 4 fails or operates incorrectly, this signal is not sent via the control line 12, and the memory auxiliary interface is active.

This activation or deactivation feature that has just been described is significant only inasmuch as it may be desirable to authorize the access memory bank only when regular access using the processor 4 is no longer possible.

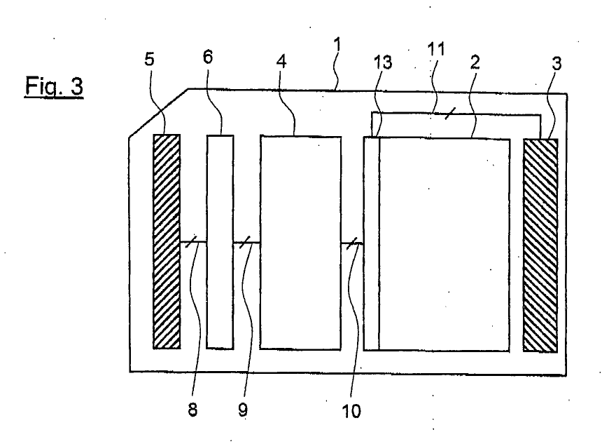

FIG. 3 shows a third exemplary embodiment. In this case, the additional contact bank 3 is connected to the memory interface 13 directly via an auxiliary bus 1. This means that within the memory card 1 there is no kind of logic adaptation, but rather that in this example the memory chip's interface is ultimately connected to the outside via the additional contact bank. This means that the entire functionality, which is otherwise undertaken by the processor 4 and the interface circuit 6 in normal operation, needs to be provided by the external appliance. Although this means that somewhat higher demands are made on the external appliance that reads the data from the flash memory bank 2, it significantly reduces the additional complexity required within the memory card 1.

It will again be pointed out that the invention is naturally not limited to the exemplary embodiments shown, particularly not to the memory cards merely indicated in outline, but can be applied to any type of semiconductor storage media that can have different semiconductor memory devices in the form of one or more chips. It goes without saying that the contact bank 5 and/or the additional contact bank 3 could be implemented with an appropriate contactless interface. A measure of this kind is not associated with excessive complexity but rather merely requires appropriate adaptation of the interface circuit.

What is claimed is:

1. A mass memory device comprising:
a nonvolatile semiconductor memory device;
a contact bank;
an access device, wherein the nonvolatile semiconductor memory device can be accessed via the contact bank using the access device; and
an auxiliary device that can used to read data stored in the semiconductor memory device by bypassing the access device.

2. The mass memory device as claimed in claim 1, wherein the access device is adopted to deactivate the auxiliary device during operation of the access device.

3. The mass memory device as claimed in claim 1, further comprising an interface circuit coupled between the contact bank and the access device, wherein data is transferred between the nonvolatile semiconductor memory device and the contact bank under the control of the access device during normal operation and wherein the access device is bypassed during alternate operation.

4. The mass memory device as claimed in claim 3, wherein the nonvolatile semiconductor memory device comprises a memory interface arrangement for access.

5. The mass memory device as claimed in claim 4, wherein the memory interface arrangement is designed such that it is possible to read the data from the nonvolatile semiconductor memory device via the memory interface arrangement by bypassing the access device.

6. The mass memory device as claimed in claim 1, further comprising an additional contact bank, wherein data are read via the additional contact bank.

7. The mass memory device as claimed in claim 6, wherein at least one memory interface arrangement is provided, the at least one memory interface arrangement being used to read data stored in the nonvolatile semiconductor memory device via the additional contact bank by bypassing the access device.

8. The mass memory device as claimed in claim 6, further comprising a memory interface arrangement for access using the access device and a memory auxiliary interface device, wherein data stored in the nonvolatile semiconductor memory device can be read via the additional contact bank.

9. The mass memory device as claimed in claim 1, wherein the nonvolatile semiconductor memory device, the contact bank, and the access device are located on a board, the auxiliary device being located off the board.

10. The mass memory device as claimed in claim 1, wherein the nonvolatile semiconductor memory device, the contact bank, the access device and the auxiliary device are located on a board.

11. A semiconductor memory card comprising:
a nonvolatile semiconductor memory device;
a processor arrangement, wherein the processor arrangement can be used to access the nonvolatile semiconductor memory device; and
an auxiliary circuit arrangement that can be used to read data stored in the nonvolatile semiconductor memory device.

12. The semiconductor memory card as claimed in claim 11, further comprising:
a contact bank via which the processor arrangement can be used to access the nonvolatile semiconductor memory device; and
an auxiliary contact bank via which the auxiliary circuit arrangement can be used to read data stored in the nonvolatile semiconductor memory device.

13. A mass memory device comprising:
a nonvolatile semiconductor memory;
a contact bank;
an access device, wherein the nonvolatile semiconductor memory can be accessed via the contact bank using the access device; and
means for accessing the nonvolatile semiconductor memory by bypassing the access device.

14. The mass memory device of claim 13, wherein the means for accessing comprises a second contact bank.

15. The mass memory device of claim 14, wherein the means for accessing further comprises an auxiliary memory interface coupled between the nonvolatile semiconductor memory and the second contact bank.

16. The mass memory device of claim 15, further comprising a control line coupled between the access device and the auxiliary memory interface such that the auxiliary memory interface is deactivated when the access device is in operation.

17. The mass memory device of claim 14, wherein the memory device includes an interface coupled to the access device and wherein the means for accessing further comprises an auxiliary bus coupled between the interface and second contact bank.

18. The mass memory device of claim 13, further comprising an interface circuit coupled between the contact bank and the access device.

19. The mass memory device of claim 18, wherein the means for accessing comprises a bypass bus coupled between the interface circuit and the nonvolatile semiconductor memory.
